(19) United States
(12) Patent Application Publication
(10) Pub. No.: US 2016/0005016 A1
(43) Pub. Date: Jan. 7, 2016

(54) Metering System For Software Licenses

(71) Applicant: Cetrus LLC, San Ramon, CA (US)

(72) Inventors: Uri Eliahu, Alamo, CA (US); Amir R. Sheibani, San Ramon, CA (US); Cory A. Montini, Walnut Creek, CA (US); Michael S. McCormack, Danville, CA (US); David E. Lieberman, Tracy, CA (US)

(21) Appl. No.: 14/852,402

(22) Filed: Sep. 11, 2015

Related U.S. Application Data
(63) Continuation of application No. 12/718,560, filed on Mar. 5, 2010.
(60) Provisional application No. 61/159,533, filed on Mar. 12, 2009.

(51) Int. Cl. G06Q 20/14; G06Q 20/12; G06Q 20/40

(52) U.S. Cl. CPC G06Q 20/145; G06Q 20/405; G06Q 20/1235

(57) ABSTRACT

A software distribution service provides time-based licensing of software. Third-party software is augmented with functionality to enable tracking based on usage, and is downloaded through a network to a user's workstation. A user logs into an account over the network to verify account details and a sufficient balance with an authentication server. If verified, the augmented software is activated, and the time of usage is tracked. During use, the augmented software periodically communicates with the authentication server to deduct a metered-usage fee from the user's pre-paid account balance.

### CROSS-REFERENCE TO RELATED APPLICATIONS

This application is a continuation of U.S. patent application Ser. No. 12/718,560, filed Mar. 5, 2010, which claims priority under 35 U.S.C. §119(e) to U.S. Provisional Patent Application Ser. No. 61/159,533, filed Mar. 12, 2009, entitled “Metering System for Software Licenses,” which applications are incorporated herein by reference in their entireties.

### BACKGROUND

1. Field of the Invention

This invention relates generally to controlling access and usage of software. Specifically, this invention relates to time-based metering of software.

2. Description of the Related Art

Several common issues arise when software users, especially technical practitioners, wish to use technical software. A number of these applications are narrowly focused and are useful to a very limited number of technical practitioners. Further, many applications are highly complex and specialized in nature, very complicated to operate, and are often very expensive, sometimes with retail prices of ten of thousands of dollars. Further, these specialized software programs are typically infrequently used by practitioners. The infrequent use of these titles combined with their very high retail prices leads to two common problems. First, technical practitioners will often avoid purchasing these software titles all together. Second, piracy of specialized technical software is commonplace. Technical practitioners, whether knowingly or unknowingly, will often violate the terms of their software license agreements through unauthorized duplication or concurrent usage.

Several attempts to defeat piracy or make expensive licenses more “accessible” or cost-effective have been devised. One method is through the use of passwords or hardware keys (i.e., a “dongle”). Both can be defeated by pirates. Further, hardware keys are easily broken, are often misplaced or stolen, and offer limited portability. A second method is through the use of floating licenses that are shared among a work group, often through a network platform. However, the software still remains very expensive, and users are often unsatisfied because they have to wait until a license is available and not in use by another user. Piracy and abuse of licensing terms are commonplace under such systems. A third method is through time-limited versions of the software. A time-limited license is offered for a fraction of the full license cost, but the fractional license is only operable for a limited period of time, commonly for a few weeks or months.

A variation of the time-limited license is flat rental fees for software. The software, typically hosted on the software publisher website, may be rented on a timed (e.g., monthly) basis. The software is typically available on a secure website hosted by the software publisher. Software as a Service (SaaS) or “cloud computing” are examples of this method. The software and computing power reside with the software publisher or host; the user's workstation is relegated to that of a “dummy” terminal. Accordingly, the performance of the software is heavily reliant on the computing power of the host as well as the speed of the connection.

In some systems, a user may license software that resides on a user's workstation for a period of time. Generally, a user requests a specific amount of rental time for a given application. A remote server grants the requested usage and charges the user a fee before software usage occurs. The user then may use the software while connected to the Internet or “off-line”. There are several shortcomings associated with this model. First, a user must request a given amount of usage time beforehand; this can lessen the user experience as they need to “recharge” or be refunded when usage time is underestimated or overestimated, respectively. Second, if a user were to be working while not connected to the Internet, it may be difficult to enforce or confirm the pre-allotted usage time.

As a result of the shortcomings of the available technologies, it is desirable to provide an efficient solution to license specialized technical software on time-based, metered usage basis that allows for more cost-effective access to a range of users, minimizes the incentive for theft or violating the spirit of software licensing terms, enhances user portability and access, leverages the computing power of the user's resident workstation, and provides a secure means to approve, monitor, and charge for time-based metered usage.

### SUMMARY

In various embodiments, the present invention provides methods and systems for providing on-demand, metered usage licensing of software applications. A software distribution service provides time-based licensing of software. Third-party software is augmented with functionality to enable tracking based on usage. The augmented software can be downloaded through a network protocol, such as the Internet, to a user's workstation. Before the time-based software may be used, the user supplies account login information to verify that the user has a valid account with a sufficient account balance to use the time-based software. If the permission is verified and the user has sufficient funds to use the software, the software on the user's workstation is activated, and the time of usage is tracked. The metered usage fee is deducted from the user's pre-paid account balance. In one embodiment, the usage time is tracked to the specific software program used as well as to the user name, project, clients, and/or other customizable categories. In another embodiment, a discounted or premium price is assigned to a specific computing operation for the duration of the operation to capture an appropriate fee for the operation. The user may generate an invoice for the specific usage and submit to the project client for reimbursement.

In one implementation, during use, the time-based software continuously or periodically communicates with an authentication server over a network to verify the user is authorized for continued use and deducts from the user account balance. If the pre-paid balance in the user's account reaches a minimum floor, the balance will be automatically replenished by a “recharge amount” through a secure transaction. In one embodiment, a user may download, free of charge, unlimited copies of available applications to unlimited workstations provided they have a valid account and sufficient funds for use.

### BRIEF DESCRIPTION OF THE DRAWINGS

FIG. 1 is a high-level block diagram of the computing environment in accordance with an embodiment of the invention.

FIG. 2 is a flow chart illustrating a method of creating metered-usage software applications from vendors, in accordance with one embodiment.

FIG. 3 is a flow chart illustrating a method of establishing a user account, in accordance with one embodiment.

FIG. 4 is an example screen shot depicting the software library purchase page.

FIG. 5 is an example screen shot depicting the new account set-up screen.

FIG. 6 is an example screen shot depicting a data input screen for the user account administrator.

FIG. 7 is an example screen shot depicting the credit card information input screen.

FIG. 8 is an example screen shot depicting the administrator screen for adding users to an existing account.

FIG. 9 is an example screen shot depicting the set-up of the project tracking.

FIG. 10 is an example screen shot depicting the application download window.

FIG. 11 is a flow chart illustrating a method of metering a user's usage of a software package through the user's account, in accordance with one embodiment.

FIG. 12 is an interaction diagram illustrating the interaction of an augmented software application, a shell, and an authentication server, in accordance with one embodiment.

FIG. 13 is an example screen shot depicting a user login window.

FIG. 14 is an example screen shot depicting the project tracking input window.

FIG. 15 is an example screen shot depicting the auto-pause prompt window.

FIG. 16 is an example screen shot depicting the account usage report generation window.

FIG. 17 is an example screen shot depicting the vendor's administration user tracking page.

One skilled in the art will readily recognize from the following discussion that alternative embodiments of the structures and methods illustrated herein may be employed without departing from the principles of the invention described herein.

### DETAILED DESCRIPTION OF THE EMBODIMENTS

### System Overview

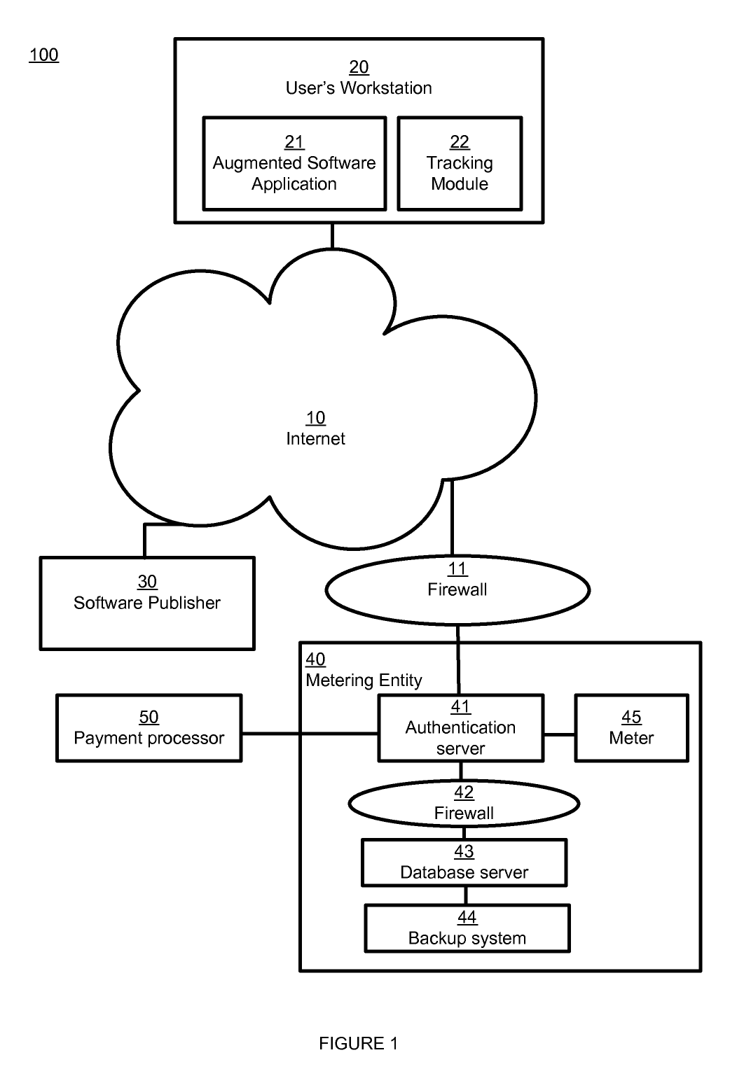

FIG. 1 is an illustration of the computing environment 100 in accordance with one embodiment of the invention. The computing environment 100 includes at least one software publisher 30, a metering entity 40, a payment processor 50, and a user's workstation 20, all connected via a network 10, such as the Internet.

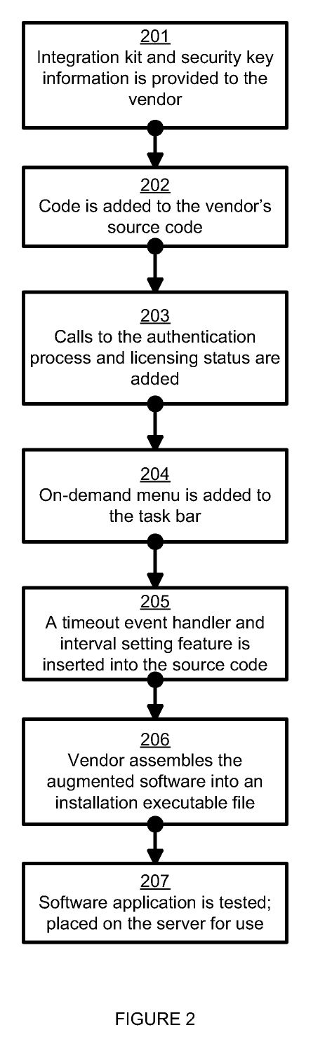

The software publisher 30, also referred to herein as a “vendor” provides an on-demand, metered usage version of the software available for use on a user's workstation 20. The version of the software provided by the software publisher 30 is referred to herein as an augmented software application 21. The process by which a software publisher 30 creates the augmented software application 21 will be described in greater detail with reference to FIG. 2. In one implementation, the software publisher 30 sends a copy of the augmented software application 21 to the metering entity 40 that handles the distribution of the augmented software application 21 to the user's workstation 20. However, in other implementations, the software publisher 30 may provide a copy of the augmented software application 21 directly to the user's workstation 20 in response to a user's request.

The metering entity 40 meters the usage at the user's workstation 20 of the augmented software application 21. The metering entity 40 includes an authentication server 41, a firewall 42, a database server 43, a backup system 44, and a meter 45. In one implementation, the authentication server 41 is accessible through a public Internet address. The authentication server 41 verifies credentials provided from the user's workstation 20 to access a user account, which is stored behind a firewall 42 by a database server 43. A user pre-pays for use of a software application through a user account stored by the database server 43. Subsequently, through communications with the user's workstation 20, the authentication server 41 can track the duration of time of use of the augmented software application 21 by using a meter 45, and can deduct corresponding amounts from the user's pre-paid account. Also stored by the database server 43 are accounts for the software publishers 30, and optionally copies of the augmented software applications 21. The backup system 44 serves as a redundant storage repository for the information stored by the database server 43. As an added layer of security, in one embodiment, the metering entity 40 is protected behind an external firewall 11.

The payment processor 50 processes payments made by users for access to the augmented software applications 21. When a user decides to license an augmented software application 21, payment authorization is transmitted from the user's workstation 20 to the metering entity 40. The payment is processed by the payment processor 50, and the user's account stored by the database server 43 is updated to reflect the transaction. In one implementation, the payment processor 50 is a credit card processor, but other types of payment processors may also be used.

The user's workstation 20 is a computer system on which a user accesses the licensed augmented software application 21. As described above, the user's workstation 20 provides credentials to the authentication server 41 of the metering entity 40 to access the user's account. Once the account credentials are verified, the user can download the augmented software application 21 via the Internet 10, to the user's workstation 20. The downloaded augmented software application 21 is ready to use, and usage is tracked on a metered basis by a meter 45 of the metering entity 40. The augmented software application 21 communicates with the authentication server 41 during use. In one embodiment, the augmented software application 21 requires the user's workstation 20 to have a working Internet connection to the authentication server 41 to allow for real-time tracking of the metered use. In one embodiment, software use may be tracked by the meter 45 and recorded according to the task, project, and/or client, which allows a user to associate software use to a respective task, project, and/or client for reimbursement purposes (a process which is also known as Expense-to-Project or E2P).

In connection with downloading the augmented software application 21 to the user's workstation 20, a tracking module 22 is also downloaded. The tracking module 22, located outside of the augmented software application, prompts the user to enter credentials when the augmented software application 21 is started. Once a connection has been established with the authentication server 41, the augmented software application 21 communicates to the authentication server 41 through the tracking module 22 to enable tracking of duration of use by the meter 45. Additionally, in some implementations, the tracking module monitors software activity, pauses a meter at the metering entity 40 when a threshold limit of inactivity has been reached, can disable the augmented software application 21 if a security breach is detected, and logs communication with the authentication server 21 for debugging purposes.

One example of a tracking module 22 is a dynamic-link library (DLL). The augmented software application 21, through an application programming interface (API) call to the DLL, sends the credentials as a HTTPS GET request to the authentication server 41. In one implementation, the DLL is registered within the Windows operating system, and may be obfuscated for security purposes. With this example, all user functionality is directly installed into the source code of the augmented software application 21. The DLL directly links the augmented software application 21 and the authentication server 41 for communication purposes.

Another example of a tracking module 22 is a “shell” or “dashboard” user interface. In some implementations, all user and callout functionality resides within the shell and are visible to the user. For instance, all menu options are located directly in the shell user interface as opposed to in the menu or toolbar of the augmented software application 21. During operation, several subroutine calls placed within the augmented software application 21 invoke the subroutines contained within the shell. These subroutines perform the software tracking functions during software use. With the shell alternative, one DLL is used to communicate between the shell and the augmented software application 21. A second, separate DLL is used to communicate between the shell and the authentication server 41. These DLLs contain a security utility that confirms the communication pattern and order from the augmented software application 21 to the authentication server 41 via the shell. In the event that a security breach is attempted to bypass the required communication pattern and order, a security utility terminates the software session.

When the augmented software application 21 operating with the shell is opened or launched, the augmented software application 21 communicates with the shell via a DLL. The shell, through its user interface, receives the user's login credentials, which are, in turn, communicated to the authentication server 41 via a separate DLL. Assuming the credentials have been accepted, the augmented software application 21 is allowed to operate. During operation, the shell regularly communicates with the authentication server 41 and the augmented software application 21 to confirm the connection is maintained, the user is actively operating the software, and the meter 45 is continuing operation. This communication also serves as a security feature; in the event that the communication link has been broken, the use of the augmented software application 21 is terminated to prevent de-coupling of the metering function from the software use.

When use of the augmented software application 21 is actively terminated by the user, the shell communicates with the authentication server 41 to cease the metering of the software use session. In the event that a threshold timeout limit is reached, the shell will pause the metering of the software as well as suspend the functionality of the augmented software application 21. The use can be restored by the user (again invoking the meter 45). Alternatively, the shell can prompt the user to actively terminate the session.

Another example of a tracking module 22 is a “wrapper” interface. The wrapper uses the shell interface described above, but eliminates the need for the source code of the vendor's application to be directly augmented. Instead of callouts placed directly within the source code of the augmented software application 21, the subroutine calls to the shell are incorporated in the executable file of the augmented software application 21 installer. Hence, the wrapper “wraps” the augmented software application 21 or is handled externally. During use, the wrapper uses a Windows API call to a start the augmented software application 21. The wrapper loads encrypted, unusable portions of the augmented software application 21 into the memory of the workstation. Once the authentication server 41 has approved the user's credentials, the wrapper decrypts the encrypted portions of the augmented software application 21 and re-assembles the augmented software application 21 for use. With the exception of the operation of the augmented software application 21 from the workstation's memory, the initiation, operation, metering, and termination of a software use session are the same as with the use of the shell.

As an optional added security measure to prevent spoofing, a security key is also compiled directly into the application code. The authentication server 41 is also aware of the application's security key. Upon startup, the augmented software application 21 generates a random message and sends it to the authentication server 41 via the tracking module 22 during the initial login process. The authentication server 41 encrypts the random message using the security key and sends it back in its response via a secure connection, for example using SSL encryption. The augmented software application 21 then decrypts the encrypted message using the application's security key and compares it to the original random message sent from the augmented software application 21. The augmented software application 21 terminates unless these messages are equal. This ensures that the connection was made to the actual authentication server 41.

Creating Metered-Usage Software Applications from Vendors

FIG. 2 is a flow chart illustrating a method for creating metered-usage software applications from vendors, in accordance with one embodiment. In one implementation, an application-specific proprietary code is implemented into each vendor's application, forming an augmented software application 21. The proprietary source code is designed to provide the vendor's application with a secure means to communicate with the authentication server 41.

In step 201, an integration kit and security key information are provided to a vendor. In one embodiment, the implementation kit includes instructions, source code, and a demonstration program. The demonstration program serves two purposes. First, it provides an example of an augmented software application. Second, when the demonstration program is used, it automatically installs a tracking module 22 using an executable file in the vendor's software application. As an alternative, the vendor may manually install and register the DLL as opposed to running the demonstration program. As an additional alternative, the shell interface automatically loads its necessary DLLs using its installer.

In step 202, the vendor adds proprietary code to their software application to create the augmented software application 21. The source code required for the integration is loaded into an integrated development environment (IDE). In one embodiment, the code is added in the user interface. The code is contained in two files; a library module and a header file. During the integration process, calls are made to functions contained in the library module. The header file contains the prototype declarations for these functions. An include directive for the header file to be used for the support library is added to the source code files. The header file provides a declaration of all of the functions to be called from the .LIB file during operation as well as instructions as to how to call the functions. As an alternative, using the shell interface, the calls are made to the API DLL with or without a header file. In this alternative, the DLL communicates between the shell application and the authentication server.

In step 203, calls to initiate the authentication process and the licensing status are inserted into the application source code. The exact sequence varies greatly in this step based on the parent programming language of the software application. In one implementation, a vendor application code and a passphrase code are entered for security purposes. The calls to initiate the authentication process and the licensing status allow the application to communicate with the server. In one implementation, during the communication at the time of credential verification, a Boolean flag is sent from the authentication server 41 to the workstation 20. If FALSE, the augmented software application 21 will not start and the user is forced to exit. If TRUE, the augmented software application 21 is initialized and a metering timer is invoked.

In step 204, several features may be added to the augmented software application 21. These include menu items such as: Pause Meter, Change Billing, Who Am I, Set Inactivity Interval, Trace AutoPause, About OnDemand, and a timer event handler. The Pause Meter menu item allows the user to pause an actively running meter 45 of a user's usage time of an augmented software application 21 and pauses the corresponding augmented software application 21. The Change Billing menu item allows the user to revise billing information, such as project name or client name, assigned to the software use session. The Who Am I menu item provides information regarding the user of the program for reference purposes. The Set Inactivity Interval menu item allows the user to alter the threshold time at which the application is suspended and the meter 45 is paused. The Trace AutoPause menu item allows for debugging of the metering system as it pertains to the software session. The AboutAutoDemand provides general information pertaining to the metering system. The timer event handler is used to periodically update the screen with a countdown of the time remaining before activity timeout and to give the support library an opportunity to pause the application when the timeout occurs. These features provide functionality to the user or provide information regarding the on-demand usage of the application. In one embodiment, menu support is added by wrapping a call to the appropriate support function in the support library. As an alternative, the shell incorporates one or more of these functions and does not require separate callouts within the application code.

In step 205, the vendor builds and tests the augmented software application. During testing, a debugger can be used to identify and repair errors. In one implementation, as an additional test, the vendor enters login credentials as well as project information to confirm that the program launches correctly. In one implementation, the vendor assembles the augmented software into an installation executable file. In one embodiment, this is a “single click” executable file. The installation executable is configured to install the application and any required files, libraries, and resources.

In step 206, the augmented application is tested to confirm compatibility with the on-demand model. At this point, the augmented software application 21 is ready to be licensed by users for use on user workstations 20. In one embodiment, the augmented software application 21 placed so as to be accessible through a server of the metering entity 40.

### User Account Setup

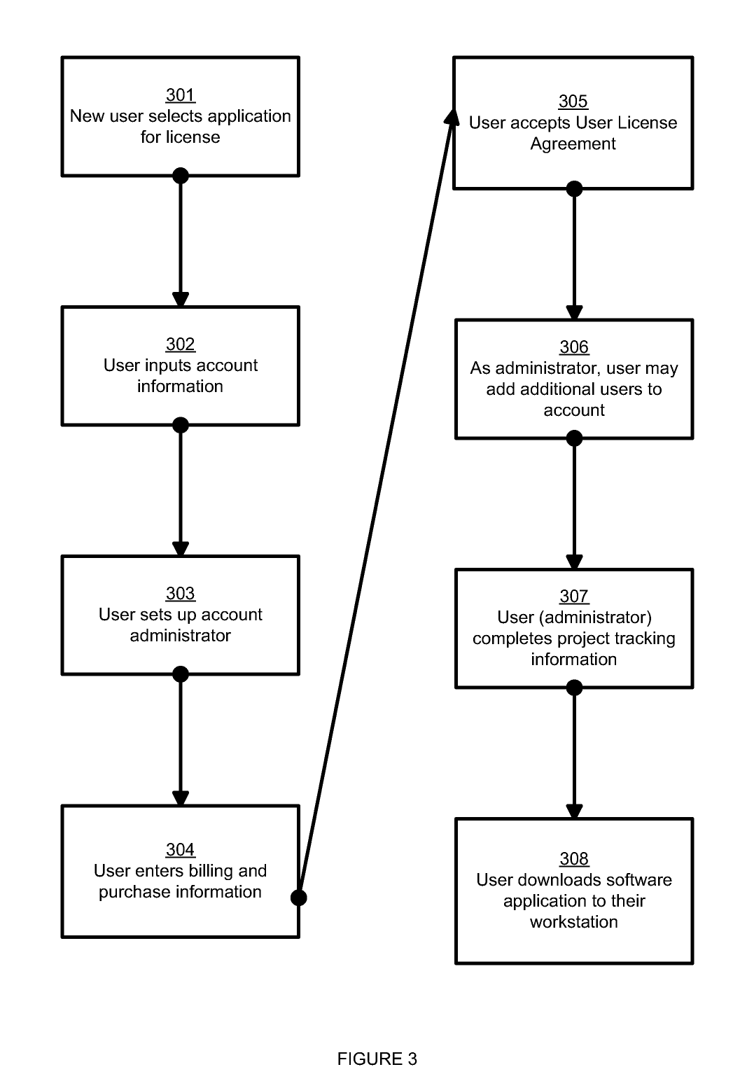

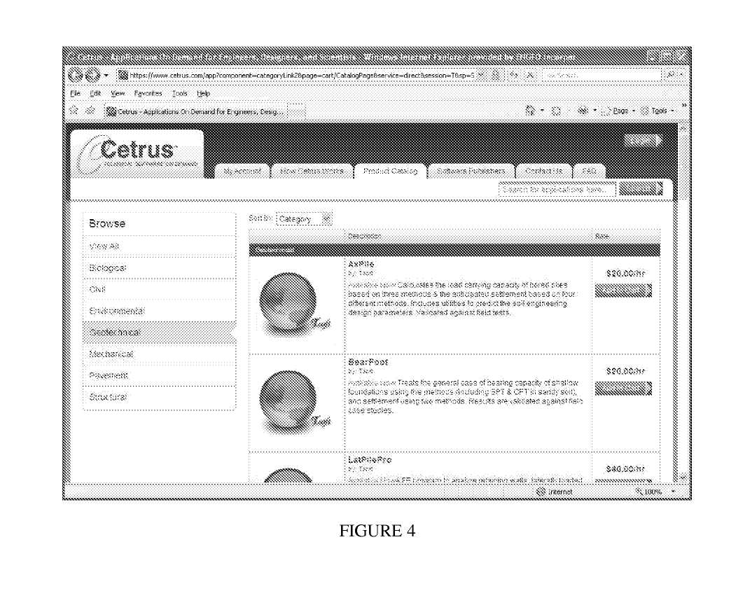

FIG. 3 is a flow chart illustrating a method of establishing a user's account, in accordance with one embodiment. The method will be described with reference to the screen shots of FIGS. 4-10.

In step 301, a new user selects a software application or multiple applications to license. FIG. 4 illustrates an application library page from which a user can make selections. The user is presented with a page to confirm or cancel the impending purchase. In one implementation, by accepting the purchase agreement the user is required to acknowledge the following items: 1) the prescribed metered usage rate; 2) pre-pay amount; 3) the recharge floor; and 4) the recharge amount. The pre-pay amount is a minimum transaction fee. It represents the initial amount that will be charged to a user's account. It typically represents a value equal to 3 to 5 hours worth of the metered usage rate in order to provide for an adequate block of rental time for use, avoid “draining” the account too quickly, and provide a buffer so the account is not drawn to zero. The user may select an amount equal to or any amount above the minimal rate. The recharge floor is a minimum account floor. When the pre-pay amount is depleted through use, it will reach this floor, at which time the account value will be replenished. The value of the replenishment is equal to the recharge amount. The recharge amount is the ongoing replenishment amount and is used throughout the use of the given account.

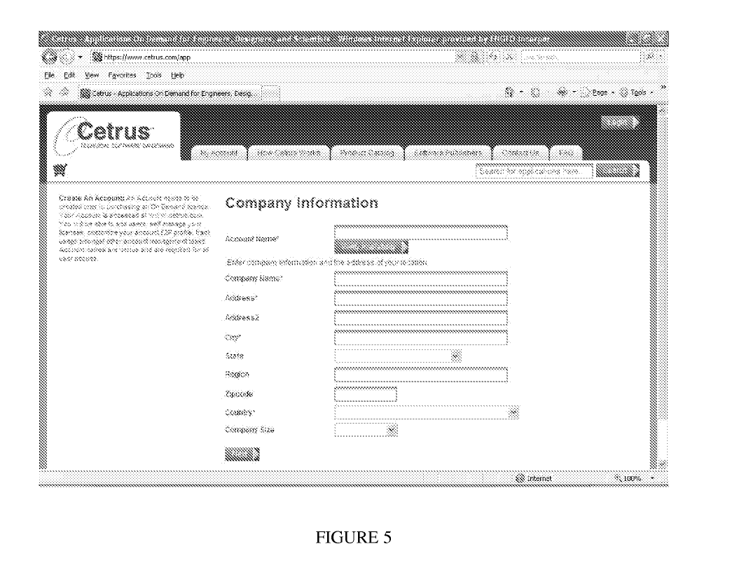

In step 302, the user inputs account information, for example, by entering the new user account “wizard” which is illustrated in FIG. 5. The user enters an account name. The account name is a unique identifier and acts as a “domain name”. The user also enters a user ID as well as typical registration information, such as name, address, telephone number, email address, etc. Once the user information is entered and confirmed, a welcome email may be automatically sent to the user. In one embodiment, duplicate account information (i.e., information that already exists in the system) is not allowed. In the event that duplicate account information is entered, an error message accompanied by clear delineation of the error results (for example, text turns red).

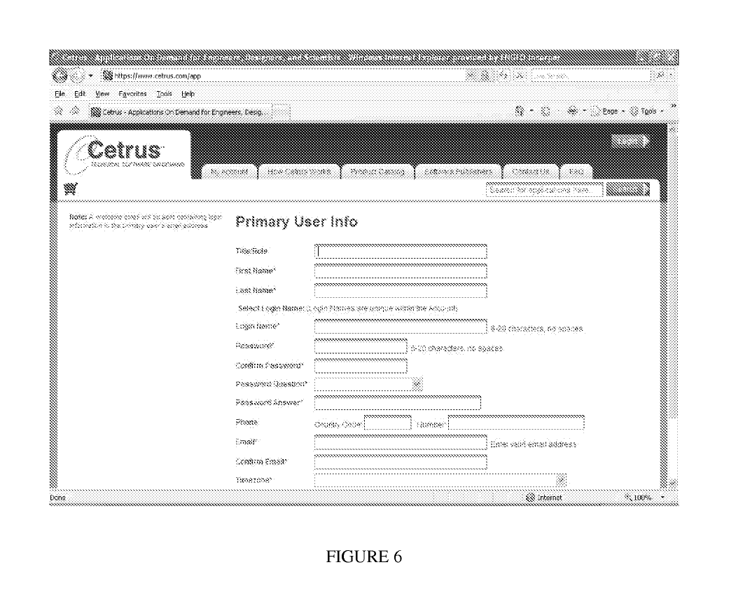

In step 303, the user sets up an account administrator. For example, the user may be prompted with another data entry box illustrated in FIG. 6 pertaining to setup for an administrator. This step is for the initial user for a given account name. This capability allows the initial user to act as or assign administrative rights to another individual. The administrator controls access to software programs; adding or removing users, applications, and controlling which users have access to each application. As an alternative to step 303, the prospective administrator may have an account and all respective account information completed on the administrator's behalf.

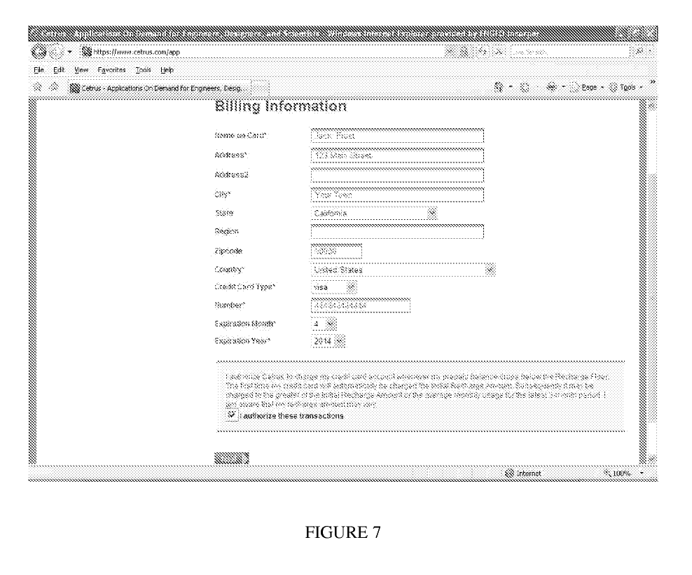

In step 304, the user enters billing information into a billing information page illustrated in FIG. 7, for example, by entering credit card information. In one embodiment, all of the information is stored, and the credit card is charged upon the initial purchase as well as at intermittent times when software use has reduced the user's account to the recharge floor. As an alternative to step 304, the user has the option to avoid entering a credit card and use an “accounts receivable” model instead. In the accounts receivable model, the tracking of use and operability are the same, except that the user is sent a periodic invoice for payment rather than pre-paying for usage through an account.

In step 305, the user accepts a user license agreement (ULA). The user is presented with a purchase screen. The screen asks the user to confirm all of the entered information and summarizes the application and charges to be incurred (for example, the title, software publisher, metered rate, and total charge). The user acknowledges the terms of the User License Agreement (ULA) by clicking “yes”; then affirmatively clicks for the purchase. In some implementations, a printable receipt is generated in a pop-up window. The user may enter notes and print the receipt prior to closing the pop-up window. In some implementations, a confirming welcome email summarizing the purchase is sent to the user. The account name, user name, and password may appear in the email.

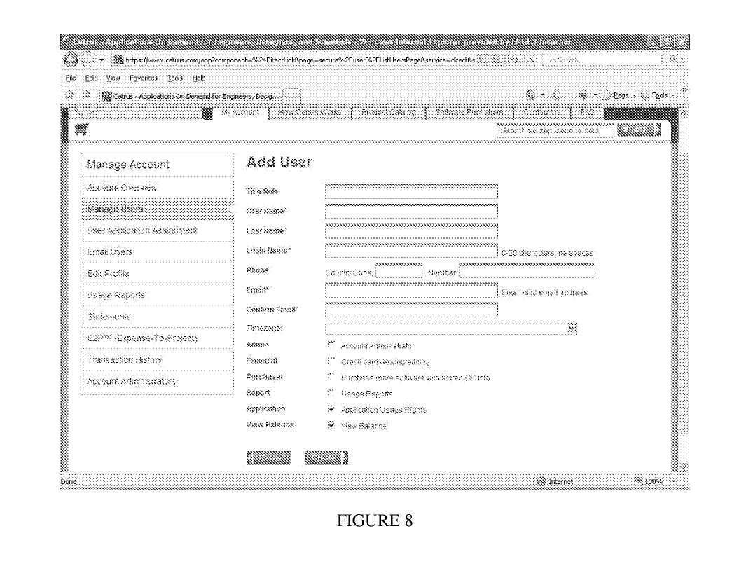

In step 306, additional users may be added by an administrator to the account using the interface depicted in FIG. 8. This conveniently allows client groups (i.e., a company, a branch, or a working group) to set up one account. To add additional users, the user with administrative credentials (“administrator”) logs into the administrator account. The administrator may amend the billing information, for example the credit card balance, in order to increase the available usage. Each user may be assigned specific rights by the administrator. These include software usage rights, software purchase rights, administrative rights, reporting rights, and access to financial information. The administrator assigns these rights at the administrator's discretion to users within the account group. As an alternative to step 306, modifying users, user rights, and tracking fields may be performed at any time. The initial account setup provides a convenient time to perform these tasks; however, the data may be entered at any time to meet the needs of user organizations. This allows users flexibility in handling changes in staffing, their client needs, and accounting system changes.

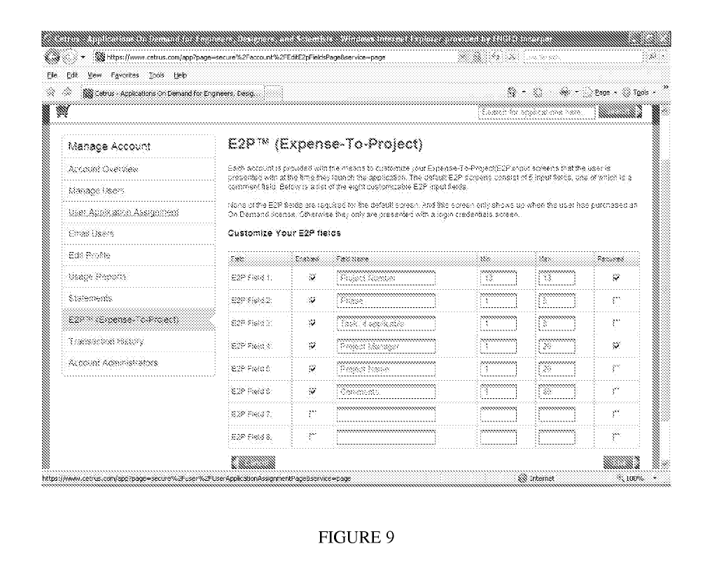

In step 307, the project tracking information is completed by the user, for example, as illustrated in FIG. 9. The expense and project tracking fields are fully customizable at the discretion of the administrator. They may include such information as project name, project number, client name, employee name, and other tracking information. The administrator has the discretion to establish these parameters as well as minimum and maximum character lengths for each field. This function allows for easy tracking of software usage, allowing the user to generate a client or project-specific invoice for reimbursement.

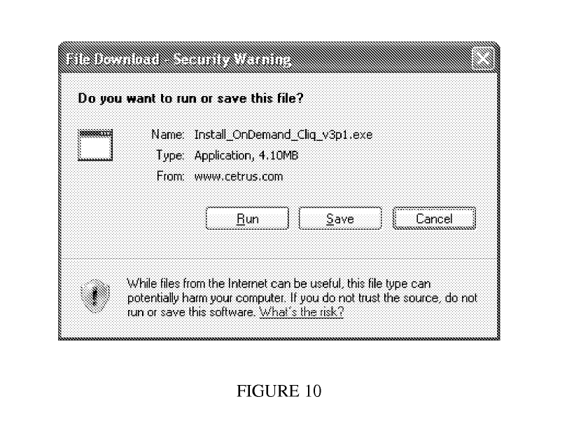

In step 308, the user is able to download software to their workstation desktop. FIG. 10 illustrates an application download window. In one implementation, when the user chooses to download the software, one executable (.exe) file is sent from the authentication server 41. The user is presented with a file run window and a security box with the option of selecting “run”, “save”, or “cancel”. The user may select any option, although “save” is recommended as it is the fastest method. The file is downloaded to the workstation desktop. This process is similar to other typical software downloads and once complete, the user can launch the application normally, for example, from an icon appearing on the user's desktop. This allows the user to have convenient access to the program and a user experience very similar to many other software programs.

### User Account Usage

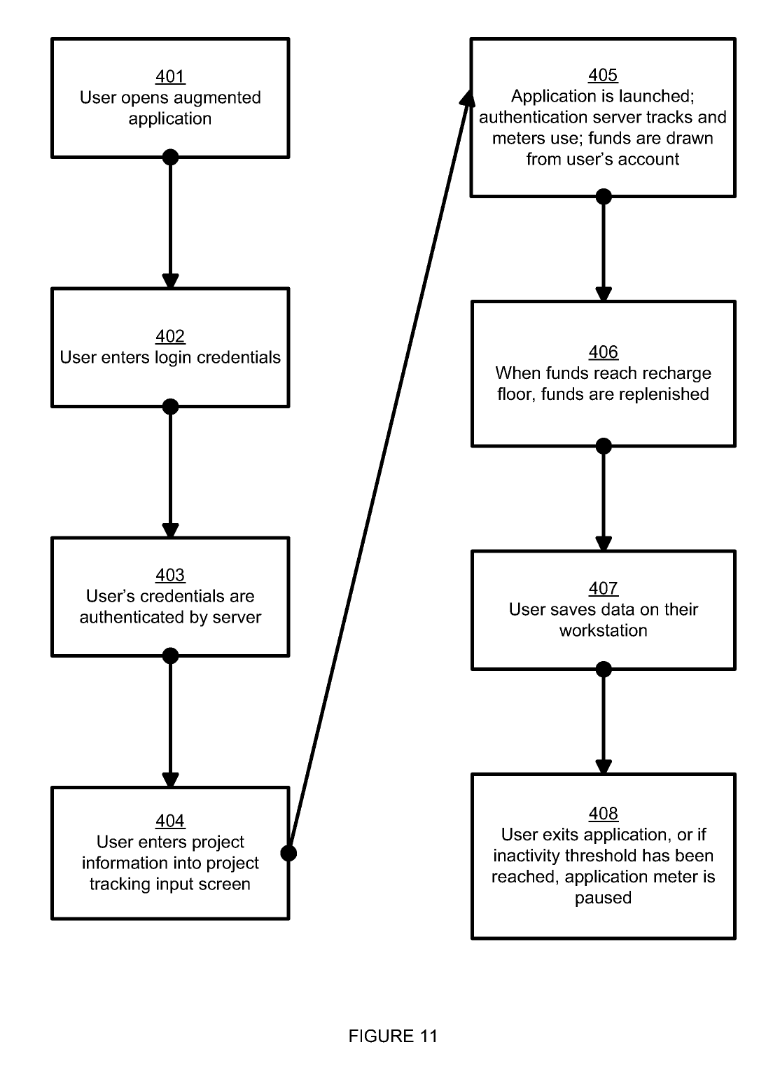

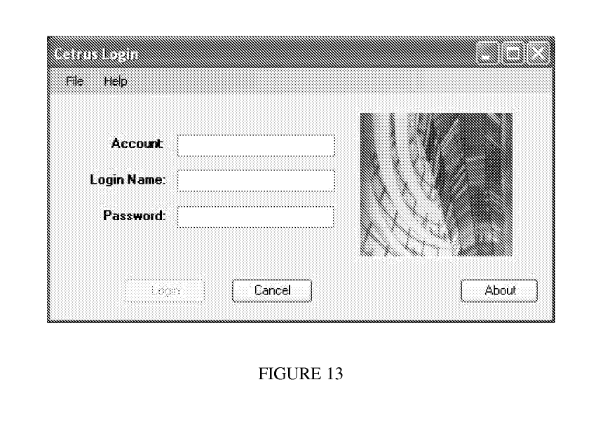

FIG. 11 is a flow chart illustrating a method of a user's usage of software, in accordance with one embodiment. The method will be described with reference to the screen shots of FIGS. 13-15.

In step 401, a user, previously having established and account and desiring to use the software, opens the augmented software application 21 on their workstation 20. In one implementation, a fully functional version of the application resides on the user's workstation 20, however, it is disabled and unable to be used until the user's credentials are verified. In one implementation, when the user opens the augmented software application, a thread will be spawned by the operating system of the user's workstation 20. However, the thread is suspended until the user's credentials are verified, at which point a notification is sent from the authentication server 41, and the thread is resumed. In implementations involving a shell, the shell resumes the thread. It is noted that in some implementations, once an account has been established (and assuming the user has permission from the account administrator), the user may download the augmented software application to an unlimited number of workstations 20 free of charge.

In step 402, when the application is opened, the user enters login credentials, for example when the user is presented with a login box as illustrated in FIG. 13. In one implementation, the user enters the name of their account, their user identification name, and a password. Once this information has been entered, the user submits these credentials. An Internet connection is established, and the credentials are submitted as an authentication request to the authentication server 41 via a secured connection. Data that identifies the augmented software application 21 is relayed by the licensing DLL, a COM Server/.NET assembly installed on the workstation 20, to the authentication server 41 via the Internet 10. The transmitted data can be encrypted for security purposes. In one implementation, information passed to the authentication server 41 over the course of the method of FIG. 11 includes vendor name, application name, user name, MAC address, IP, DLL version, login name, time in, and time out.

In step 403, the authentication server verifies the user's credentials, confirming that the user is a legitimate member of the respective user account, that the user has permission to use the specific augmented software application 21. Optionally, the authentication server 41 may also check if a sufficient balance of funds is available in the user's account for the user to use the augmented software application 21. If insufficient funds are available, the authentication server 41 may warn the user, may deny access to the augmented software application 21 until the balance is replenished, or with user consent, may attempt to recharge the balance by initiating a recharge transaction for processing by the payment processor 50.

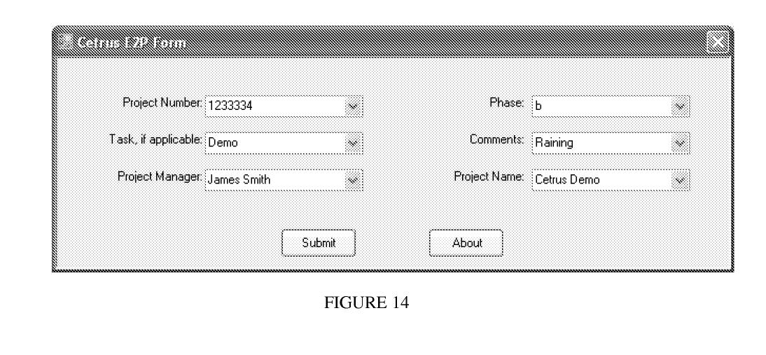

Optionally, in step 404, assuming the user's credentials have been verified and accepted, the user is presented with an optional project tracking screen. The user enters all relevant project-related data into the appropriate data entry boxes as illustrated in FIG. 14. The administrator has the ability to pre-select what data will be required and/or optional into these data fields. For example, the administrator may pre-select client name, project number, and user name as required fields, or any other combination of fields that is used in their organization for tracking and cost-recovery purposes. The character length as well as the content of each of these data fields is fully customizable. In one implementation, if the administrator chooses to not enter data for the project tracking screen, the screen will not appear during the login process for subsequent use.

In step 405, once the project-specific data has been properly entered into the tracking screen, the augmented software application 21 is opened and enabled for use. The application is a fully functional software version with capabilities similar to a “stand-alone” software version. During use, the DLL or shell communicates on a regular ongoing basis with the authentication server 41. This communication, for example, a “ping”, occurs at a regular interval, for example, every 30 or 60 seconds. The communication can serve several functions. First, it verifies the connection is still established between the user's workstation 20 and the authentication server 41. Second, it verifies that the user has proper credentials to continue with the use of the application. Third, it enables the metering entity 40 to track and record time of use. As mentioned above, the user may pause the application and the tracking meter 45 during use, rendering the application inoperable. In some embodiments, the metering entity 40 may track usage to the second. A pro-rated share of the hourly cost to operate the respective software application or a fee related to a specific software task is deducted from the user's pre-paid account.

In step 406, as the user's pre-paid account balance is depleted and reaches the recharge floor, the account is replenished by the recharge amount. The authentication server 41 communicates with the payment processor 50 to authorize charges. For example, assuming that the user's credit card stored within their respective user account remains valid, the charge is processed by the payment processor 50, and the user's account funds are replenished. As an alternative to the method described above, the user may opt for an invoice. In this case, the software usage for a given account is still tracked on a metered basis. The usage for a given time period (i.e., monthly) is summarized, and the user is sent an invoice summarizing their usage and related charges for the time period. The user then pays the invoice.

In step 407, the user, during their normal course of use of the augmented software application 21, is able to save all of their data to files maintained on their workstation 20 or other common storage device as they would with other applications that are maintained and/or used on their workstation 20.

In step 408, the user may exit the program once their desired use has ended. In one embodiment, the augmented software application 21 is exited in methods common to standard software applications. In some implementations, the user is prompted to save their data prior to exiting the application. Once the application is exited, the meter is stopped, and the deduction of funds from the user's account is also stopped. The balance remains within the user's account for subsequent use. In one embodiment, a single user's account can be used to pay for the user's use of any number of different augmented software applications 21.

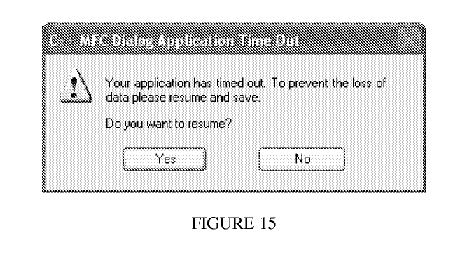

Alternatively, in step 408, an auto-pause feature is invoked if active use by the user of the augmented software application 21 is stopped. An example of an auto-pause prompt is shown in FIG. 15. This scenario may occur if a user leaves a workstation 20 for a protracted period of time. In one embodiment, the inactivity period is user-configurable, for example between 5 and 30 minutes. After the inactivity period has elapsed, a message is sent to the user to prompt them to continue use. In one embodiment, if the prompt is not actively responded to by the user, the application and meter are automatically paused. In another embodiment, if the prompt is not actively responded to by the user, the application and the meter may be terminated. As a safety precaution, in some implementations, the user's data may be saved prior to the application terminating.

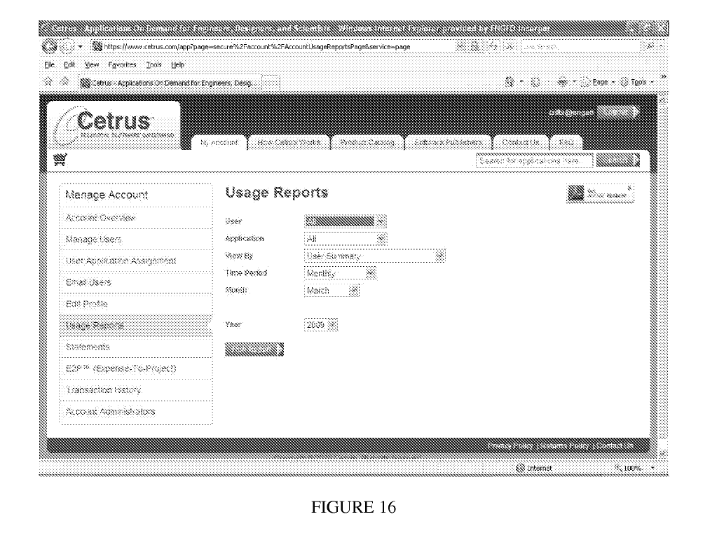

The administrator may track software usage within an account at any time by generating a usage report from the interface shown in FIG. 16. The comprehensive tracking capability allows the administrator to view usage by date, application, time, user, and project. Depending on administrative rights granted to the respective users, the user may have ability to view some or all of this information as well as related financial information.

The user or administrator may generate a report summarizing the software usage. As in the case of usage tracking, the report may summarize information based on the contents of a query, including dates, software application, user or users, project, specific project client, or any combination thereof. The report generated will reflect the project tracking data input in step 404 from the user's use of the software.

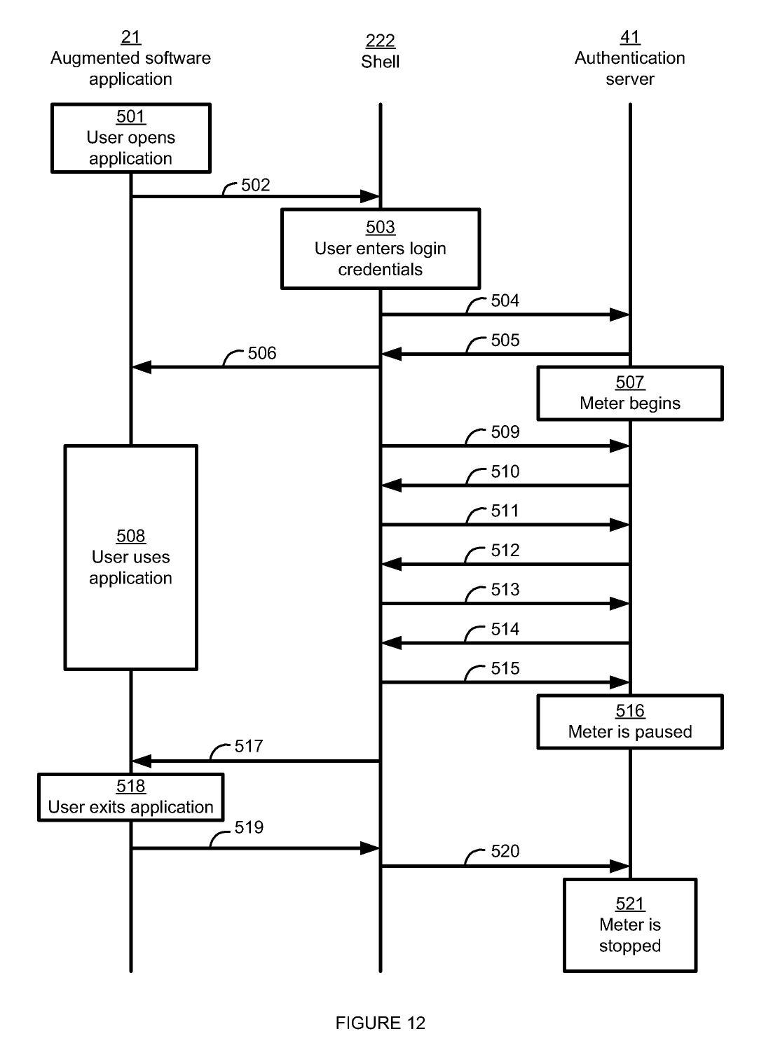

FIG. 12 is an interaction diagram illustrating the interaction of an augmented software application, a shell, and an authentication server, in accordance with an alternative embodiment of a method of metering a user's usage of a software application through the user's account. In this example, the tracking module 22 is implemented as a shell 222 that manages communications between the augmented software application 21 and the authentication server 41.

First, the user opens 501 the augmented software application 21, for example by clicking on an icon on the desktop of the user's workstation 20. The opening of the augmented software application 21 triggers a notification 502 from the augmented software application 21 to the shell 222. In response to this notification 502, the shell displays a login window for the user to enter 503 login credentials. The shell communicates 504 the login credentials to the authentication server 41 as an authentication request. The authentication server 41 responds to the login credentials by verifying the user's credentials and communicating 505 the verification to the shell 222. The shell 222 relays 506 the verification to the augmented software application 21 to enable the augmented software application 21 to be used in a user work session 508. At substantially the same time, a meter 45 at the metering entity 40 is started 507.

Over the course of a user's use 508 of the augmented software application 21, the shell 222 and authentication server 41 communicate 509-514 periodically to record the user's usage. In one implementation, the shell 222 checks the status of the augmented software application every minute, and sends an update 509, 511, 513 to the authentication server 41 to which the authentication server 41 responds 510, 512, 514, as described with reference to FIG. 11.

Once the user's use 508 of the augmented software application has ended, for example, when the user steps away from the work station 20, the shell 222 communicates 515 the stoppage to the authentication server 41. In response, the authentication server 41 pauses 516 the meter 45 running on the metering entity 40. The shell 222 also notifies 517 the augmented software application 21 of the stoppage and displays a user prompt. In one implementation, the user is provided a choice to continue a work session, or to exit the application. In the example shown in FIG. 12, the user exits 518 the application. The user exit is communicated 519 from the augmented software application 21 to the shell 222, which in turn notifies 520 the authentication server 41 that the user has exited the application so that the meter 45 can be stopped 521.

### Vendor Account

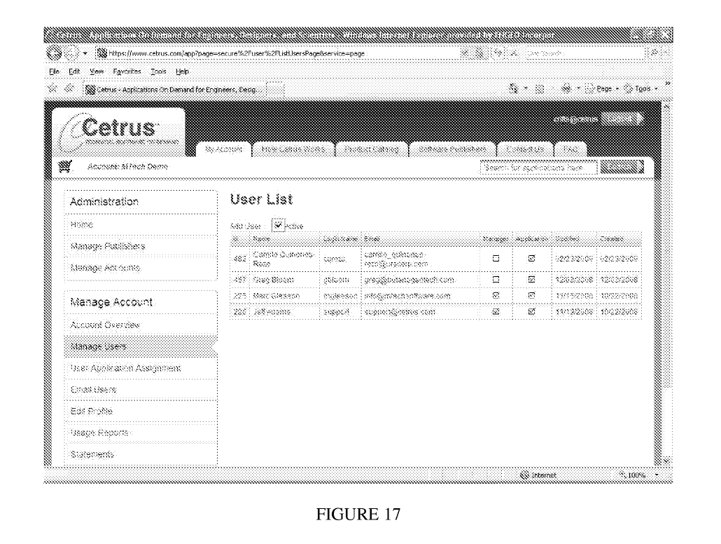

The vendor may access a vendor account stored by database sever 43 of metering entity 40. An example of a user interface for the vendor account is shown in FIG. 17. To access the account, the vendor enters their credentials, for example an account name, user name, and password. Through the vendor account, the vendor may review, at any time, usage associated with user accounts and generate customizable reports of usage, for example by application name, that include information such as user names, dates, times, and charge amounts. This account also provides vendor administrative controls, and lists the vendor's pre-approved marketing URLs. The vendor also uses the vendor account to update their contact information, marketing materials, and software descriptions.

When first establishing their vendor account, the vendor is directed to an account home page. The vendor creates application page descriptions, including metered usage rates for the specific application. The vendor may also include a URL for each application. Typically, the URL is directed to the vendor's website or an appropriate marketing page and is used to provide more information pertaining to the application, other applications or products that may be useful with the application, or other appropriate information.

In one embodiment, the vendor has the ability to establish various types of user accounts having different combinations of metering and billing features. One example is a demonstration account. The demonstration account is metered but not billed to the user, so no charges or invoices are issued. It is used by the vendor for testing and for marketing/demonstration purposes. Since the vendor can track the use of the account, the metering allows the vender to track demonstration usage, ensuring that the demonstration use is in good faith. Another example is a development test user account, where the meter runs and is billable, but a real credit card transaction does not occur. This is used for software development purposes. Another example is a product test user account, where a legitimate credit card transaction can occur, but the software use is not metered. Another example is an accounts receivable account, where, as previously described, software use is metered, but a credit card transaction does not occur. Instead, usage is tracked for a period of time, and an invoice is generated and forwarded to a user account administrator for payment. Another example is a metered usage account, where software use is metered and tracked, and the user account fund balance is adjusted as appropriate. Another example is a pay per iteration account where, instead of software use metered and billed by the unit of time in use, software use is tracked and billed on a “run,” an iterative calculation basis. Additionally, billing may be applied at a “milestone” of software use, such as when output is generated or printed. Another example is a dual metered rate account. In this example, one of two or more different billing rates may be used depending on the type of operation executed by the software. For instance, a lower billing rate may be applied during input of data, and a higher billing rate may be applied during calculation processes or when output is generated.

The present invention has been described in particular detail with respect to several possible embodiments. Those of skill in the art will appreciate that the invention may be practiced in other embodiments. First, the particular naming of the components, capitalization of terms, the attributes, data structures, or any other programming or structural aspect is not mandatory or significant, and the mechanisms that implement the invention or its features may have different names, formats, or protocols. Further, the system may be implemented via a combination of hardware and software, as described, or entirely in hardware elements. Also, the particular division of functionality between the various system components described herein is merely exemplary, and not mandatory; functions performed by a single system component may instead be performed by multiple components, and functions performed by multiple components may instead performed by a single component.

Some portions of above description present the features of the present invention in terms of algorithms and symbolic representations of operations on information. These algorithmic descriptions and representations are the means used by those skilled in the data processing arts to most effectively convey the substance of their work to others skilled in the art. These operations, while described functionally or logically, are understood to be implemented by computer programs. Furthermore, it has also proven convenient at times, to refer to these arrangements of operations as modules or by functional names, without loss of generality.

Unless specifically stated otherwise as apparent from the above discussion, it is appreciated that throughout the description, discussions utilizing terms such as “determining” or “displaying” or the like, refer to the action and processes of a computer system, or similar electronic computing device, that manipulates and transforms data represented as physical (electronic) quantities within the computer system memories or registers or other such information storage, transmission or display devices.

Certain aspects of the present invention include process steps and instructions described herein in the form of an algorithm. It should be noted that the process steps and instructions of the present invention could be embodied in software, firmware or hardware, and when embodied in software, could be downloaded to reside on and be operated from different platforms used by real time network operating systems.

The present invention also relates to an apparatus for performing the operations herein. This apparatus may be specially constructed for the required purposes, or it may comprise a general-purpose computer selectively activated or reconfigured by a computer program stored on a computer readable medium that can be accessed by the computer and run by a computer processor. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

In addition, the present invention is not described with reference to any particular programming language. It is appreciated that a variety of programming languages may be used to implement the teachings of the present invention as described herein, and any references to specific languages are provided for enablement and best mode of the present invention.

The present invention is well suited to a wide variety of computer network systems over numerous topologies. Within this field, the configuration and management of large networks comprise storage devices and computers that are communicatively coupled to dissimilar computers and storage devices over a network, such as the Internet.

Finally, it should be noted that the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention.

What is claimed is:

1. A method of metering use of software and allocating the usage to projects, the method comprising:
receiving a customized set of project tracking fields from an account administrator, wherein the account administrator has selected a field name for each project tracking field in the customized set and how many project tracking fields are in the customized set, the project tracking field names identifying project-specific information for cost-recovery or analytics purposes to be input by a plurality of users of the account into the corresponding project tracking fields via a project tracking screen before each user uses a software application to work on the identified project on the respective user's workstation, wherein each project tracking field is associated with a customizable minimum and customizable maximum number of characters, and wherein at least one of the customized set of project tracking fields is designated as required by the account administrator;
receiving, at an authentication server, an authentication request from a shell applied to a third-party software application on a user's workstation, the request including account credentials;
verifying the account credentials;
receiving project-specific inputs from the user into the customized set of project tracking fields displayed to the user on the user's workstation, the project-specific inputs including sufficient project information to distinguish the identified project from other projects worked on by the user or other users of the account;
the shell enabling use of the third-party software application on the user's workstation by notifying the third-party software application to resume a thread spawned by the operating system of the user's workstation;
responsive to receiving communications from the shell at periodic intervals during use of the third-party software application, incrementally tracking the time of use, wherein the shell provides a user interface to enable pausing of the usage of the third-party software application, and the shell is not embedded in code of the third-party software application;
assigning the incrementally tracked time of use to the identified project from the received project-tracking inputs into the customized set of project tracking fields;
periodically recharging the user's pre-paid account when a minimum account balance is reached; and
generating a project-specific report of the tracked time of use associated with the identified project for the account.

2. A metering entity for metering use of software, the metering entity comprising:
a database server storing a user's prepaid account; and
an authentication server that communicates with an augmented software application residing on a user's workstation periodically during use of the augmented software application to verify a user's usage and deduct a metered usage fee from the user's prepaid account based on the duration of usage.

3. The metering entity of claim 2, wherein the augmented software application is generated by a third-party software publisher.

4. The metering entity of claim 2, wherein the authentication server communicates with a plurality of augmented software applications residing on a user's workstation, wherein the authentication server communicates with each augmented software application periodically during use of the respective software application to verify a user's usage and deduct a metered usage fee from the user's pre-paid account.

5. The metering entity of claim 2, wherein periodically comprises once every minute.

6. The metering entity of claim 2, wherein the user's prepaid account is associated with a plurality of users.

7. The metering entity of claim 2, further comprising a pausable meter that tracks the user's usage of the augmented software application based on communications from the user's workstation, the pausable meter configured to pause when a threshold period of inactivity has been reached.

8. The metering entity of claim 7, wherein the threshold period of inactivity is a user-configurable time period.

9. The metering entity of claim 2, wherein the metered usage fee comprises a different amount per time unit based on a type of operation executed by the software.

10. The metering entity of claim 2, wherein the augmented software application comprises a software application augmented to include proprietary code to enable secure communication with the authentication server.

11. A method of metering use of software and allocating the usage to projects, the method comprising:
receiving a customized set of project tracking fields from an account administrator, wherein the account administrator has selected a field name for each project tracking field in the customized set, the project tracking field names identifying project-specific information for cost-recovery or analytics purposes to be input by a plurality of users of the account into the corresponding project tracking fields via a project tracking screen before each user uses a software application to work on the identified project on the respective user's workstation;
receiving, at an authentication server, an authentication request from a shell applied to a third-party software application on a user's workstation, the request including account credentials;
verifying the account credentials;
receiving project-specific inputs from the user into the customized set of project tracking fields displayed to the user on the user's workstation, the project-specific inputs including sufficient project information to distinguish the identified project from other projects worked on by the user or other users of the account;
enabling use of the third-party software application on the user's workstation;
responsive to receiving communications from the shell at periodic intervals during use of the third-party software application, incrementally tracking the time of use, wherein the shell provides a user interface to enable pausing of the usage of the third-party software application, and the shell is not embedded in code of the third-party software application;
assigning the incrementally tracked time of use to the identified project from the received project-tracking inputs into the customized set of project tracking fields; and
generating a project-specific report of the tracked time of use associated with the identified project.

12. The method of claim 11, further comprising periodically recharging a user's pre-paid account when a minimum account balance is reached.

13. The method of claim 11, further comprising maintaining a remaining account balance in a user's prepaid account for future use.

14. The method of claim 11, further comprising generating a report of usage by account or application.

15. The method of claim 11, wherein enabling use of the third-party software application comprises the shell notifying the third-party software application to resume a thread spawned by the operating system of the user's workstation.

16. The method of claim 11, wherein each project tracking field is associated with a customizable minimum and customizable maximum number of characters.

17. The method of claim 11, wherein at least one of the customized set of project tracking fields is designated as required by the account administrator.

18. The method of claim 11, wherein the account administrator has selected how many project tracking fields are in the customized set of project tracking fields.
